(19) United States
(12) Patent Application Publication
(10) Pub. No.: US 2026/0244971 A1
(43) Pub. Date: Aug. 20, 2026

(54) TRAINING METHOD AND ELECTRONIC DEVICE FOR QUANTUM MACHINE LEARNING

(71) Applicant: Hon Hai Precision Industry Co., Ltd., New Taipei City (TW)

(72) Inventors: Chen-Yu Liu, New Taipei City (TW); Min-Hsiu Hsieh, New Taipei City (TW)

(73) Assignee: Hon Hai Precision Industry Co., Ltd., New Taipei City (TW)

(21) Appl. No.: 19/062,043

(22) Filed: Feb. 25, 2025

(30) Foreign Application Priority Data
Feb. 17, 2025 (TW) 114105712

(51) Int. Cl. G06N 10/60; G06N 10/20

(52) U.S. Cl. CPC G06N 10/60; G06N 10/20

(57) ABSTRACT

This disclosure proposes a training method for quantum machine learning and an electronic device. The training method includes: configuring a quantum circuit to output probabilities of multiple qubits, where the quantum circuit comprises multiple gates with circuit parameters; mapping the qubits to multiple model parameters of a neural network, where multiple bases are calculated based on the qubits, and the quantity of the bases is greater than or equal to the quantity of the model parameters; inputting data into the neural network and calculating a loss based on the output of the neural network; and updating the circuit parameters in the quantum circuit according to the loss.

### CROSS-REFERENCE TO RELATED APPLICATION

This application claims the priority benefit of Taiwan application serial no. 114105712, filed on Feb. 17, 2025. The entirety of the above-mentioned patent application is hereby incorporated by reference herein and made a part of this specification.

### BACKGROUND

### Technical Field

The present disclosure relates to a training method combining quantum computing and machine learning.

### Related Art

Machine learning techniques face significant challenges in handling growing model complexity and efficiently utilizing computational resources. As machine learning models become increasingly complex, the quantity of required parameters also increases dramatically, leading to inefficient resource utilization issues during training and deployment processes. Furthermore, with the rise of Quantum Machine Learning (QML), this field faces additional technical challenges, including how to encode traditional data into quantum states. For example, when processing an image, each pixel in the image may be encoded into a corresponding quantum state, and then quantum computing may be used for inference. However, as image resolution increases, complex transformations are needed to convert pixels into quantum states. This approach may limit the size of input that can be processed and may also result in loss of information.

### SUMMARY

The present disclosure proposes a training method and electronic devices that combine quantum circuits to train model parameters in a neural network. This approach may reduce the quantity of parameters required for training, and the trained neural network may also be applied to conventional computers.

The present disclosure proposes a training method for quantum machine learning, applicable to an electronic device. This training method includes: configuring a quantum circuit to output probabilities of multiple qubits, wherein the quantum circuit includes multiple gates, these gates having multiple circuit parameters; mapping the qubits to multiple model parameters of a neural network, wherein multiple bases are calculated based on the qubits, and the quantity of these bases is greater than or equal to the quantity of model parameters; inputting data to the neural network and calculating loss according to the output of the neural network; and updating the circuit parameters in the quantum circuit according to the loss.

In an embodiment of the present disclosure, the gates include multiple controlled-NOT gates and multiple rotation gates, wherein the circuit parameters correspond to the rotation gates.

In an embodiment of the present disclosure, the step of mapping qubits to model parameters of the neural network includes: determining a first basis of the qubits, and calculating a first probability of the first basis; generating a first vector according to the first basis and the first probability; and inputting the first vector to a mapping neural network to obtain one of the model parameters.

In an embodiment of the present disclosure, the training method further includes: determining a second basis of the qubits, and calculating a second probability of the second basis, wherein the second basis is different from the first basis; generating a second vector according to the second basis and the second probability; and inputting the second vector to the mapping neural network to obtain another model parameter.

In an embodiment of the present disclosure, the training method further includes: updating multiple model parameters in the mapping neural network according to the loss.

In an embodiment of the present disclosure, the training method further includes: amplifying the first probability; and generating the first vector according to the amplified first probability.

The step of amplifying the first probability is performed based on the following equation where Pⱼ is the first probability, α is a constant, j is a positive integer, and N is a quantity of the qubits

$${P}_{j} \to α \times tan h ( α \times {2}^{N - 1} {P}_{j} )$$

In an embodiment of the present disclosure, the step of mapping qubits to model parameters of the neural network includes: determining a first basis of the qubits, and calculating a first probability of the first basis; and inputting the first probability to a mapping function to obtain one of the model parameters.

In an embodiment of the present disclosure, the training method further includes: selecting a portion of the model parameters, and changing the signs of this portion.

From another perspective, an embodiment of the present invention proposes an electronic device, including a memory and a processor. The memory stores multiple instructions, and the processor is communicatively connected to the memory for executing the instructions in the memory to perform the aforementioned training method.

To make the above-mentioned features and advantages of the present invention more evident and understandable, embodiments are specifically cited below, and detailed explanations are provided in conjunction with the accompanying FIG.s as follows.

### BRIEF DESCRIPTION OF THE DRAWINGS

FIG. 1 is a schematic diagram illustrating an electronic device according to an embodiment.

FIG. 2 is a schematic diagram illustrating the operation of a quantum circuit and a neural network according to an embodiment.

FIG. 3 is a flowchart illustrating a training method for quantum machine learning according to an embodiment.

FIG. 4 is a schematic diagram illustrating the training of quantum machine learning according to another embodiment.

### DESCRIPTION OF THE EMBODIMENTS

Some embodiments of the present invention will be described in detail in conjunction with the accompanying FIG.s. In the following description, when the same component symbols appear in different FIG.s, they will be regarded as the same or similar components. These embodiments are only a part of the present invention and do not disclose all possible implementations of the present invention. More precisely, these embodiments are only examples of the systems and methods in the scope of patent claims of the present invention.

Regarding the terms “first,” “second,” etc. used in this document, they do not specifically indicate order or sequence, but are merely used to distinguish components or operations described with the same technical terms.

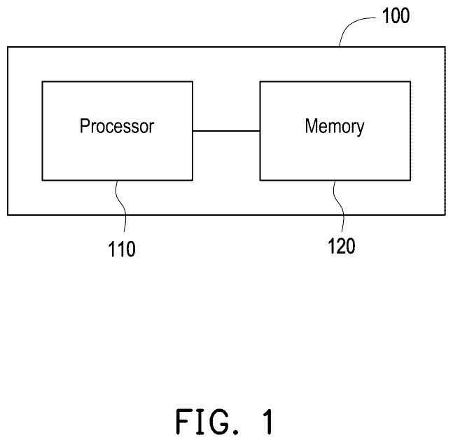

FIG. 1 is a schematic diagram illustrating an electronic device according to an embodiment. Referring to FIG. 1, an electronic device 100 may be a tablet computer, personal computer, laptop computer, server, distributed computer, cloud server, industrial computer, or various electronic devices with computing capabilities, but the present invention is not limited thereto. The electronic device 100 includes a processor 110 and a memory 120, where the processor 110 is communicatively connected to the memory 120. This communication connection may be achieved through any wired or wireless communication means, or through the Internet. The processor 110 may be a central processing unit, microprocessor, microcontroller, deep-learning processing unit (DPU), neural network processing unit (NPU), tensor processing unit (TPU), Application Specific Integrated Circuits (ASIC), Programmable Logic Device (PLD), etc. The memory 120 may be random access memory, read-only memory, flash memory, floppy disk, hard disk, optical disc, USB flash drive, magnetic tape, or a database accessible through the Internet, which stores multiple instructions. The processor 110 will execute these instructions to perform a training method for quantum machine learning, which will be explained below.

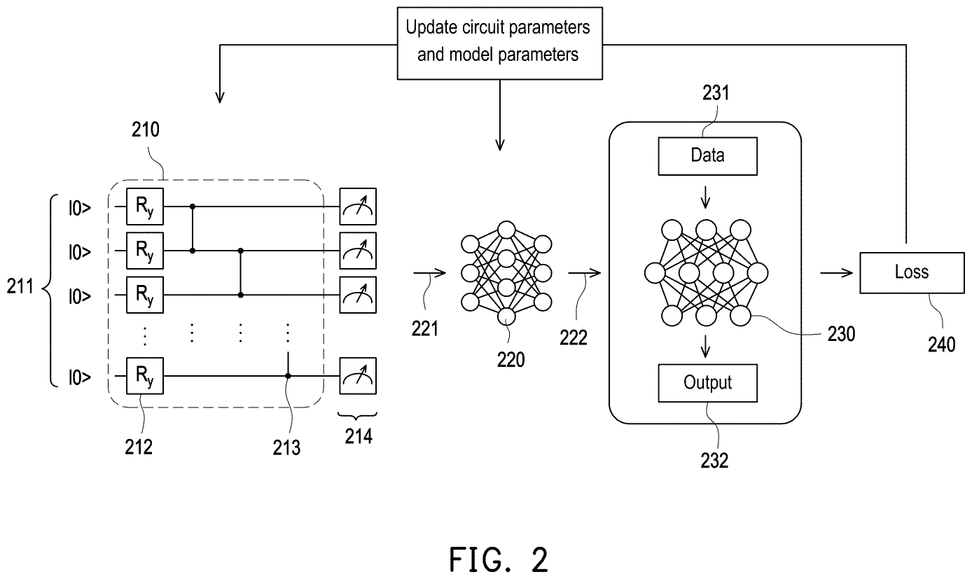

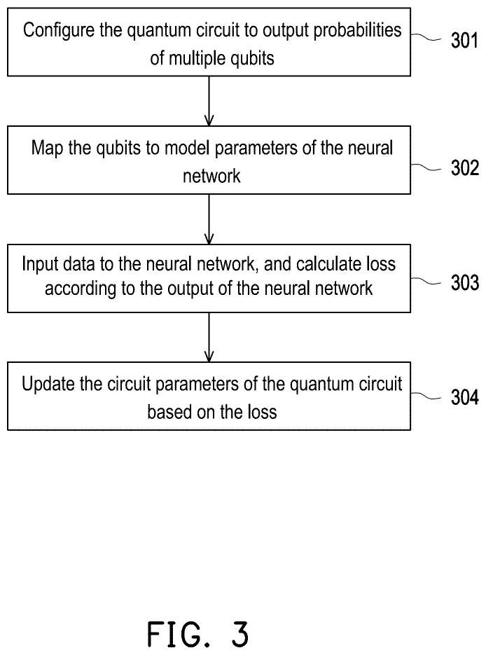

FIG. 2 is a schematic diagram illustrating the operation of a quantum circuit and a neural network according to an embodiment. FIG. 3 is a flowchart illustrating a training method for quantum machine learning according to an embodiment. Referring to FIG. 2 and FIG. 3, this embodiment primarily involves a quantum circuit 210, a mapping neural network 220, and a neural network 230. The quantum circuit 210 utilizes a total of N qubits, which are used to calculate 2\hat{ }N bases. On the other hand, the neural network 230 includes M model parameters. The neural network 230 may include a convolutional neural network (CNN), a recurrent neural network (RNN), a transformer, an attention layer, etc. This disclosure does not limit the architecture of the neural network 230. Notably, each model parameter correspond to one basis, and the quantity of bases is greater than or equal to the quantity of model parameters. In other words, the number of bases, which is calculated exponentially based on the number of qubits, is greater than or equal to the number of model parameters, for example, 2\hat{ }N≥M. In some embodiments, N=┌log_2 M┐, but this disclosure is not limited thereto. In other words, the aforementioned bases can cover M model parameters. The mapping neural network 220 is used to map N qubits to M model parameters. For example, the probability of each basis may correspond to a model parameter. Since the probability range from 0 to 1, while model parameters may be negative, the mapping neural network 220 can map the range from 0 to 1 to the range of −∞ to ∞.

In step 301, the quantum circuit 210 is configured to output probabilities of multiple qubits. Specifically, the input of the quantum circuit 210 is initial states 211 of the qubits, which may be, for example, |0 [symbol] , but the present invention is not limited thereto. The quantum circuit 210 includes multiple gates, such as multiple rotation gates 212 and multiple controlled-NOT (CNOT) gates 213. The rotation gates 212 can be represented by the following equation 1.

$${R}_{y} ( μ ) = [ \text{} \begin{matrix}cos ( μ / 2 ) & - sin ( μ / 2 ) \\ sin ( μ / 2 ) & cos ( μ / 2 )\end{matrix} \text{} ] \qquad [ Equation 1 ]$$

Where μ is referred to as a circuit parameter. In this embodiment, the rotation gates 212 perform rotations around the y-axis, but in other embodiments, they may rotate around the x-axis or the z-axis. Alternatively, in other embodiments, the quantum circuit 210 may also include a SWAP gate, a controlled-Z (CZ) gate, a Hadamard gate, etc. This disclosure is not limited thereto. In the embodiment illustrated in FIG. 2, the gates are arranged in a block structure, meaning that each layer corresponding to a qubit is configured with a rotation gate and a controlled-NOT gate. However, such block structures may be repeated multiple times, and this disclosure does not limit the number of repetitions.

The output of the quantum circuit 210 is probabilities 214 of the qubits, and the probability for each basis may be calculated through measurement. In this embodiment, the quantum circuit 210 is simulated by software, but in other embodiments, the quantum circuit 210 may also be implemented with physical circuits, and the present disclosure is not limited thereto.

In step 302, the qubits are mapped to model parameters of the neural network. In some embodiments, a vector 221 is generated as the input to the mapping neural network 220 based on a basis and its corresponding probability. For example, if there are seven qubits and one of the bases is “0100100”, the probability of this basis is | [symbol] 0100100|ψ [symbol] |²=0.023, where W represents the quantum state. Accordingly, the generated vector 221 is [0,1,0,0,1,0,0,0.023], with a length of 8. The mapping neural network 220 may be, for example, a multilayer perceptron (MLP), but this disclosure is not limited thereto. The output 222 of the mapping neural network 220 is a model parameter (which may also be referred to as a weight) in the neural network 230. Since the mapping neural network 220 outputs one model parameter at a time, different bases must be repeatedly input to the mapping neural network 220 to compute different model parameters. For example, another basis “0100101” has a probability of 0.017. Based on this basis and probability, another vector 221 is generated, represented as [0,1,0,0,1,0,1,0.017]. This vector 221 is input into the mapping neural network 220 to obtain another model parameter.

In summary, the operation of the mapping neural network 220 may be represented by the following Equation 2.

$${G}_{\vec{γ}} ( \vec{{x}_{l}} ) = {θ}_{i} \qquad [ Equation 2 ]$$

Where \vec{γ} represents the model parameters of the mapping neural network 220. G_{\vec{γ}} denotes the mapping neural network 220. \vec{x_{ι}} is the vector 221 corresponding to the i-th basis, while θᵢ is the model parameter of the neural network 230 (corresponding to the i-th basis). Notably, if 2\hat{ }N>M, not all bases will correspond to model parameters, and those bases without corresponding parameters do not need to be input into the mapping neural network 220.

Since the sum of the probabilities for all bases is 1, these probabilities are usually relatively small. In some embodiments, the probability of each basis is amplified, and then the vector 221 is generated according to the amplified probability. For example, the probability may be amplified according to the following Equation 3.

$${P}_{j} \to α \times tan h ( α \times {2}^{N - 1} {P}_{j} ) \qquad [ Equation 3 ]$$

Where Pⱼ represents the probability. α is a constant that can be determined experimentally. j is a positive integer. In other embodiments, the probability can be input into any function for amplification, which may include polynomial functions, exponential functions, etc. This disclosure is not limited thereto.

In step 303, data 231 is input to the neural network 230, and loss 240 is calculated according to the output 232 of the neural network 230. The data 231 may be image data, text data, audio data, binary data, or any kind of data. The present disclosure is not limited in this regard. The output 232 may include one or more numerical values. When the neural network 230 is used to process classification problems, the output 232 represents a category; when the neural network 230 is used to process regression problems, the output 232 is a numerical value; when the neural network 230 serves as a generative model, the output 232 may also be image data, text data, audio data, binary data, etc. The present disclosure does not limit the content of the output 232.

Taking classification problems as an example, the loss function may be the following Equation 4.

$${ℓ}_{CE} = - \frac{1}{{N}_{d}} {\sum }_{n = 1}^{{N}_{d}} [ {y}_{n} log {\hat{y}}_{n} + ( 1 - {y}_{n} ) log ( 1 - {\hat{y}}_{n} ) ] \qquad [ Equation 4 ]$$

Where [symbol] _{CE} represents the loss 240. N_{d} denotes the number of training samples. yₙ is the true label, while ŷₙ is the output of the neural network 230. The equation 4 above is used to compute cross-entropy loss. However, in other embodiments, mean squared error or other loss functions may also be used. This disclosure is not limited thereto.

In step 304, the circuit parameters of the quantum circuit 210 are updated based on the loss 240. This update can be performed using gradient descent and the Adam optimizer. This disclosure does not restrict the choice of optimization algorithms. On the other hand, in the embodiment of FIG. 2, the model parameters \vec{γ} of the mapping neural network 220 are also updated based on the loss function. In this embodiment, the number of parameters to be trained is O(polylog(M)) rather than M, which is the number of model parameters in the neural network 230. As a result, the number of required training parameters is significantly reduced. In an experiment, the neural network 230 contained 285,226 model parameters, but using the method disclosed here, only 23,258 training parameters were required—less than 1/10 of the total parameters—while the difference in test accuracy between the two approaches was less than 2%.

On the other hand, the trained neural network 230 may be applied to a conventional computer (without requiring a quantum computer). The input to the neural network 230 is data used in traditional applications, and there is no need to encode this data into qubits, which also reduces hardware requirements.

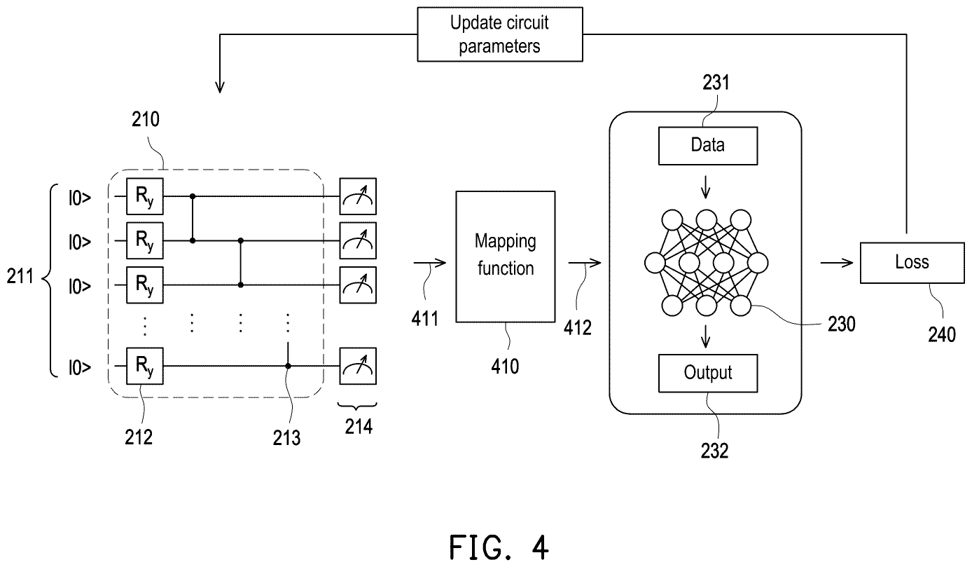

FIG. 4 illustrates a schematic diagram of quantum machine learning training according to another embodiment. Referring to FIG. 4, the difference between FIG. 4 and FIG. 2 lies in replacing the mapping neural network 220 with a mapping function 410. After inputting a probability 411 of a basis into the mapping function 410, a model parameter 412 in the neural network 230 is obtained. For example, some model parameters can correspond to a single basis, while others can correspond to multiple bases. When a model parameter corresponds to a single basis, it is equal to the probability of that basis. When a model parameter corresponds to multiple bases, it is equal to the average probability of those bases. In some embodiments, 2\hat{ }N-M model parameters are first selected, where these parameters correspond to the probability of two different bases. In this case, the mapping function is represented by the following Equation 5.

$${{{θ}_{j} = \frac{1}{2} ( \vert 〈 i \vert ψ 〉 \vert}^{2} + ( \vert 〈 k \vert ψ 〉 \vert}^{2} ) , i \neq k \qquad [ Equation 5 ]$$

Where i and k are positive integers, and θⱼ is the j-th model parameter. For the remaining model parameters, they are set to be equal to the probability of the corresponding basis, and in this case, the mapping function is represented by the following Equation 6.

$${{θ}_{j} = \vert 〈 i \vert ψ 〉 \vert}^{2} \qquad [ Equation 6 ]$$

Since probability range from 0 to 1, it is necessary to generate negative model parameters. In some embodiments, a portion (e.g., half) of the model parameters is selected, and their signs are inverted. For example, when the positive integer j is even, the model parameter θⱼ remains unchanged; and when j is odd, the sign of the model parameter θⱼ is flipped. In this embodiment, the model parameter θⱼ is also amplified using the same method described in Equation 3.

The mapping function described above is only an example. Those skilled in the art may design other mapping functions according to the disclosed means above. The present disclosure is not limited in this regard.

Although the present invention has been disclosed in the above embodiments, it is not intended to limit the invention. Any person skilled in the art may make some modifications and refinements without departing from the spirit and scope of the invention. Therefore, the protection scope of the present invention shall be defined by the appended claims.

What is claimed is:

1. A training method for quantum machine learning and performed by an electronic device, the training method comprising:
configuring a quantum circuit to output a plurality of probabilities of a plurality of qubits, wherein the quantum circuit comprises a plurality of gates, the gates having a plurality of circuit parameters;
mapping the qubits to a plurality of model parameters of a neural network, wherein a plurality of bases are calculated based on the qubits, a quantity of the bases is greater than or equal to a quantity of the model parameters;
inputting data to the neural network, and calculating a loss according to an output of the neural network; and
updating the circuit parameters in the quantum circuit according to the loss.

2. The training method of claim 1, wherein the gates comprise a plurality of controlled-NOT gates and a plurality of rotation gates, and the circuit parameters correspond to the rotation gates.

3. The training method of claim 1, wherein the step of mapping the qubits to the model parameters of the neural network comprises:
determining a first basis of the qubits, and calculating a first probability of the first basis;
generating a first vector according to the first basis and the first probability; and
inputting the first vector to a mapping neural network to obtain one of the model parameters.

4. The training method of claim 3, further comprising:
determining a second basis of the qubits, and calculating a second probability of the second basis, wherein the second basis is different from the first basis;
generating a second vector according to the second basis and the second probability; and
inputting the second vector to the mapping neural network to obtain another one of the model parameters.

5. The training method of claim 3, further comprising:
updating a plurality of model parameters in the mapping neural network according to the loss.

6. The training method of claim 3, further comprising:
amplifying the first probability; and
generating the first vector according to the amplified first probability.

7. The training method of claim 6, wherein the step of amplifying the first probability is performed according to a following equation:
$${P}_{j} \to α \times tan h ( α \times {2}^{N - 1} {P}_{j} )$$
wherein Pⱼ is the first probability, α is a constant, j is a positive integer, and N is a quantity of the qubits.

8. The training method of claim 1, wherein the step of mapping the qubits to the model parameters of the neural network includes:
determining a first basis of the qubits, and calculating a first probability of the first basis; and
inputting the first probability to a mapping function to obtain one of the model parameters.

9. The training method of claim 8, further comprising:
selecting a portion of the model parameters, and changing a sign of the selected portion.

10. An electronic device, comprising:
a memory, storing a plurality of instructions;
a processor, communicatively connected to the memory and configured to execute the instructions to perform a plurality of steps:
configuring a quantum circuit to output a plurality of probabilities of a plurality of qubits, wherein the quantum circuit comprises a plurality of gates, the gates having a plurality of circuit parameters;
mapping the qubits to a plurality of model parameters of a neural network, wherein a plurality of bases are calculated based on the qubits, a quantity of the bases is greater than or equal to a quantity of the model parameters;
inputting data to the neural network, and calculating a loss according to an output of the neural network; and
updating the circuit parameters in the quantum circuit according to the loss.

11. The electronic device of claim 10, wherein the gates comprise a plurality of controlled-NOT gates and a plurality of rotation gates, and the circuit parameters correspond to the rotation gates.

12. The electronic device of claim 10, wherein the step of mapping the qubits to the model parameters of the neural network comprises:
determining a first basis of the qubits, and calculating a first probability of the first basis;
generating a first vector according to the first basis and the first probability; and
inputting the first vector to a mapping neural network to obtain one of the model parameters.

13. The electronic device of claim 12, wherein the steps further comprise:
determining a second basis of the qubits, and calculating a second probability of the second basis, wherein the second basis is different from the first basis;
generating a second vector according to the second basis and the second probability; and
inputting the second vector to the mapping neural network to obtain another one of the model parameters.

14. The electronic device of claim 12, wherein the steps further comprise:
updating a plurality of model parameters in the mapping neural network according to the loss.

15. The electronic device of claim 12, wherein the steps further comprise:
amplifying the first probability; and
generating the first vector according to the amplified first probability.

16. The electronic device of claim 15, wherein the step of amplifying the first probability is performed according to the following equation:
$${P}_{j} \to α \times tan h ( α \times {2}^{N - 1} {P}_{j} )$$
wherein Pⱼ is the first probability, α is a constant, j is a positive integer, and N is a quantity of the qubits.

17. The electronic device of claim 10, wherein the step of mapping the qubits to the model parameters of the neural network includes:
determining a first basis of the qubits, and calculating a first probability of the first basis; and
inputting the first probability to a mapping function to obtain one of the model parameters.

18. The electronic device of claim 17, wherein the steps further comprise:
selecting a portion of the model parameters, and changing a sign of the portion.
